(19) United States
(12) Patent Application Publication
(10) Pub. No.: US 2013/0328846 A1
(43) Pub. Date: Dec. 12, 2013

(54) CHARACTERIZATION OF TRANSISTORS ON A DISPLAY SYSTEM SUBSTRATE USING A REPLICA TRANSISTOR

(71) Applicants: Shafiq M. Jamal, Pleasanton, CA (US); Hopil Bae, Sunnyvale, CA (US); Sang Y. Youn, Cupertino, CA (US); Wei H. Yao, Cupertino, CA (US)

(72) Inventors: Shafiq M. Jamal, Pleasanton, CA (US); Hopil Bae, Sunnyvale, CA (US); Sang Y. Youn, Cupertino, CA (US); Wei H. Yao, Cupertino, CA (US)

(73) Assignee: Apple Inc., Cupertino, CA (US)

(21) Appl. No.: 13/610,703

(22) Filed: Sep. 11, 2012

Related U.S. Application Data
(60) Provisional application No. 61/657,602, filed on Jun. 8, 2012.

(51) Int. Cl. G06F 3/038

(52) U.S. Cl. 345/211

(57) ABSTRACT

Better performance can be provided for a display system that has semiconductor microelectronic components such as demultiplexors, gate line and data line drivers, and pixel switches formed on the display substrate, e.g., a glass substrate that constitutes part of an active matrix display panel. A constituent transistor of one of these microelectronic components, e.g., a pixel thin film transistor (TFT) that is part of a particular display element, may be characterized using a replica component that emulates the behavior of the component.

### CLAIM OF PRIORITY

This application claims the benefit of U.S. Provisional Patent Application 61/657,602 entitled Characterization of Transistors on a Display System Substrate using a Replica Transistor, filed Jun. 8, 2012, the entire contents of which are incorporated herein by reference.

### FIELD

An embodiment of the invention relates to circuitry for characterizing the electrical characteristics of transistor devices on transparent substrates as part of a display system. Other embodiments are also described.

### BACKGROUND

Flat panel displays such as liquid crystal display (LCD), plasma, and organic light emitting diode (OLED) are typically used in consumer electronics devices such as computer, gaming consoles, media players, and portable telephones, among others. A flat panel display contains an array of display elements that each receive a signal that represents the digital picture element to be displayed at that location of the respective element. This signal is referred to as a data value or data line signal and is applied to a carrier electrode of a thin film transistor (TFT) that is coupled to and integrated with the display element. Another carrier electrode of the transistor is connected to a display element charge storage circuit, e.g., a liquid crystal capacitor. The TFT and its connected liquid crystal capacitor are referred to here as a “pixel.” A signal at the control electrode of the transistor, referred to as a gate signal, modulates or turns on and off the transistor to apply the data line signal to the charge storage circuit which produces an analog pixel signal across the liquid crystal capacitor that controls the contribution of the particular connected display element to the overall display image.

Thousands or millions of copies of the display element including its associated TFT (e.g., an LCD cell and its associated field effect transistor, or an organic LED) are reproduced in the form of an array, on a transparent substrate such as a plane of glass or plastic. The array is overlaid with a grid of data lines and gate lines. The data lines serve to deliver the data signals to the carrier electrodes of the transistors and the gate lines serve to apply the gate signals to the control electrodes of the transistors. In other words, each of the data lines is coupled to a respective group of display elements, typically referred to as a column of display elements, while each of the gate lines is coupled to a respective row of display elements.

Each data line is coupled to a data line driver circuit that receives digital control and data signals from a signal generator. The latter translates incoming digital pixel values (for example, red, green and blue pixel values) into data signals (with appropriate timing). The data line driver then performs the needed voltage level shifting to produce a data line signal with the needed fan-out (current capability).

The display element, the switch element and the grid of data lines and gate lines are typically formed using microelectronic semiconductor processing techniques directly on the transparent substrate. This conserves space and allows for a direct and immediate connection for each o the millions of pixels. However, microelectronics formed on a glass substrate do not behave the same as those formed on a silicon substrate. The TFTs on the glass substrate have inconsistent performance and degrade quickly over time and with use. As a result, the quality, accuracy, and appearance of the display changes as the transistor behavior changes.

The changes can result in slow and inconsistent response times on the display as the TFT requires higher inputs to obtain the same response or as the TFT develops a capacitance or impedance that slows its reaction time. The degradation can also cause transient or even permanent changes in color as the response characteristics of the TFT for a particular color change over time and change differently from that of another color pixel. In the worst case, the pixel is “dead” and remains either on or off at all times as the TFT no longer responds to its gate signal

### SUMMARY

Better performance can be provided for a display system that has semiconductor microelectronic components such as demultiplexors, gate line and data line drivers, and pixel switches formed on the display substrate, e.g., a glass substrate that constitutes part of an active matrix display panel. A constituent transistor of one of these microelectronic components, e.g., a pixel thin film transistor (TFT) that is part of a particular display element, may be characterized using the following technique.

In a normal mode of operation, a transistor drive circuit, e.g., a gate line driver, drives an original transistor and also a replica of the original transistor (that is also formed on the display substrate using the same manufacturing process.) Then, when a test mode is selected, the replica transistor becomes connected to a replica test circuit which applies test voltages to the replica transistor while a current measurement circuit measures current through the replica transistor in order to characterize the replica transistor based on the measured current. A compensation facility in the transistor drive circuit is then signaled to adjust the voltage applied to the original transistor during normal mode, based on the replica transistor characterization.

The normal mode of operation is then resumed (with the drive circuit having been adjusted.) The original transistor (as well as other similar, original transistors that are connected to the same drive circuit) is now driven in a way that compensates for the detected changes in the electrical characteristics of the replica.

Different tests can be performed to characterize the replica transistor. In one test, the replica test circuit applies a range of voltages to the gate of the replica transistor and the current measurement circuit measures current through the gate at each voltage. In another test, the replica test circuit applies a range of voltages to the source of the replica transistor and the current measurement circuit measures current through the source at each voltage. Multiplexers can be used to alternately couple the replica transistor between the transistor drive circuit and the replica test circuit.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like reference numerals indicate similar elements. It should be noted that references to “an” or “one” embodiment of the invention in this disclosure are not necessarily to the same embodiment, and they mean at least one.

FIG. 1 is a block diagram of exemplary components of an electronic device that includes a display device in accordance with an embodiment of the invention.

FIG. 2 is a perspective view of an electronic device in the form of a computer in accordance with an embodiment of the invention.

FIG. 3 is a front-view of a portable handheld electronic device in accordance with an embodiment of the invention.

FIG. 4 is a perspective view of a tablet-style electronic device that may be used in accordance with an embodiment of the invention.

FIG. 5 is a circuit diagram illustrating the structure of unit pixels that may be provided in the display device of FIG. 1 in accordance with an embodiment of the invention.

FIG. 6A is a diagram of gate leakage current through a transistor.

FIG. 6B is a diagram of drain current leakage through a transistor.

FIG. 7A is an example circuit schematic of a test apparatus for a gate leakage test in accordance with an embodiment of the invention.

FIG. 7B is an example circuit schematic of a test apparatus for a drain current test in accordance with an embodiment of the invention.

FIG. 8 is a combined block diagram and circuit schematic of a display element array system in accordance with an embodiment of the invention.

FIG. 9 is a combined block diagram and circuit schematic of a display element array test system in accordance with an embodiment of the invention.

FIG. 10A is a process flow diagram of testing a replica circuit for gate leakage current in accordance with an embodiment of the invention.

FIG. 10B is a process flow diagram of testing a replica circuit for drain leakage current in accordance with an embodiment of the invention.

### DETAILED DESCRIPTION

One or more specific embodiments will be described below. These described embodiments are provided only by way of example, and do not limit the scope of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

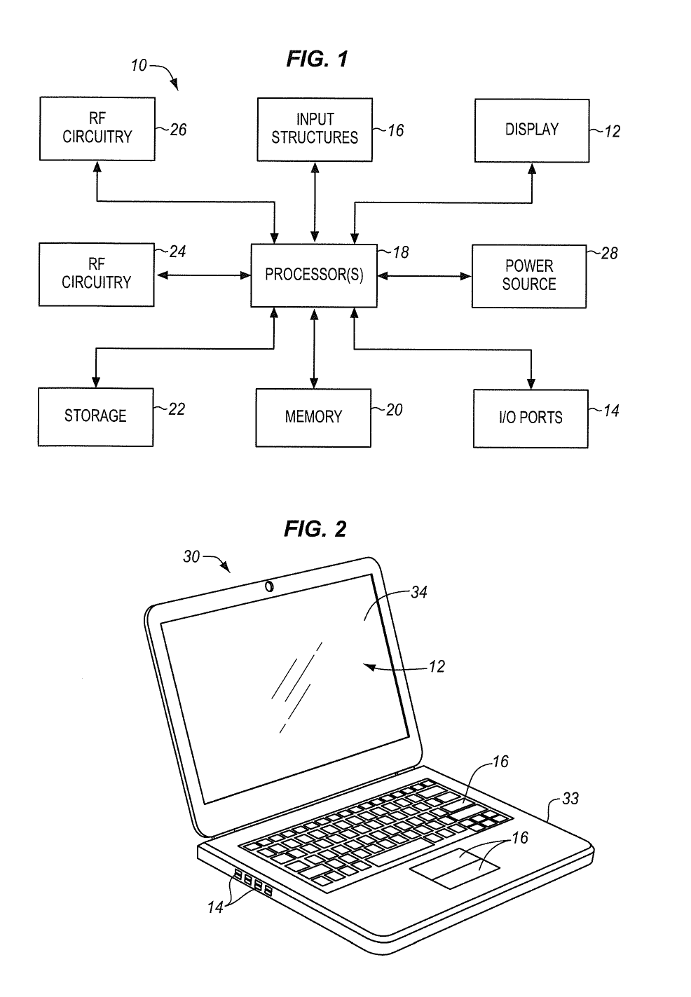

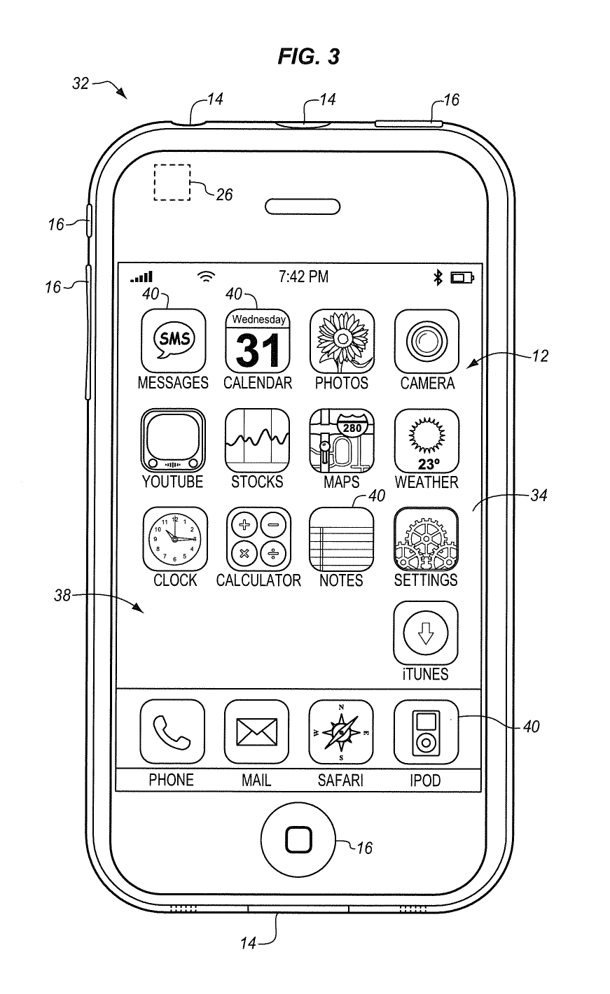

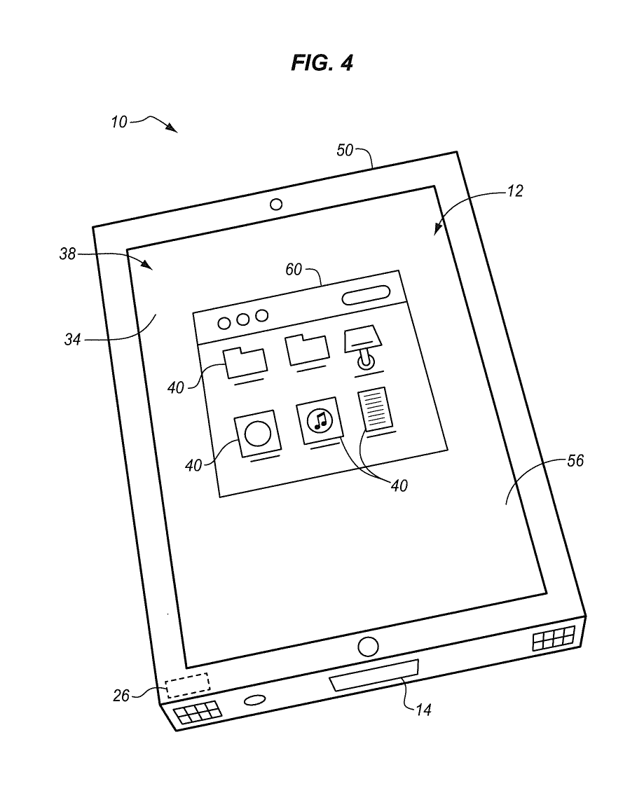

With the foregoing in mind, a general description of suitable electronic devices for performing these functions is provided below with respect to FIGS. 1-4. Specifically, FIG. 1 is a block diagram depicting various components that may be present in electronic devices suitable for use with the present techniques. FIG. 2 depicts an example of a suitable electronic device in the form of a computer. FIG. 3 depicts another example of a suitable electronic device in the form of a handheld portable electronic device. Additionally, FIG. 4 depicts yet another example of a suitable electronic device in the form of a computing device having a tablet-style form factor. These types of electronic devices, as well as other electronic devices providing comparable display capabilities, may be used in conjunction with the present techniques.

Keeping the above points in mind, FIG. 1 is a block diagram illustrating components that may be present in one such electronic device 10, and which may allow the device 10 to function in accordance with the techniques discussed herein. The various functional blocks shown in FIG. 1 may include hardware elements (including circuitry), software elements (including computer code stored on a computer-readable medium, such as a hard drive or system memory), or a combination of both hardware and software elements. It should be noted that FIG. 1 is merely one example of a particular implementation and is merely intended to illustrate the types of components that may be present in the electronic device 10. For example, in the illustrated embodiment, these components may include a display 12, input/output (I/O) ports 14, input structures 16, one or more processors 18, memory device(s) 20, non-volatile storage 22, expansion card(s) 24, RF circuitry 26, and power source 28.

The display 12 may be used to display various images generated by the electronic device 10. The display may be any suitable display such as a liquid crystal display (LCD), a plasma display, or an organic light emitting diode (OLED) display, for example. In one embodiment, the display 12 may be an LCD employing fringe field switching (FFS), in-plane switching (IPS), or other techniques useful in operating such LCD devices. The display 12 may be a color display utilizing a plurality of color channels for generating color images. By way of example, the display 12 may utilize a red, green, and blue color channel. The display 12 may include gamma adjustment circuitry configured to convert digital levels (e.g., gray levels) into analog voltage data in accordance with a target gamma curve. By way of example, such conversion may be facilitated using a digital-to-analog converter, which may include one or more resistor strings, to produce “gamma-corrected” data voltages.

In certain embodiments, the display 12 may include an arrangement of unit pixels defining rows and columns that form an image viewable region of the display 12. A source driver circuit may output this voltage data to the display 12 by way of source lines defining each column of the display 12. Each unit pixel may include a thin film transistor (TFT) configured to switch a pixel electrode. A liquid crystal capacitor may be formed between the pixel electrode and a common electrode, which may be coupled to a common voltage line (V_{COM}). When activated, the TFT may store image signals received via a respective data or source line as a charge in the pixel electrode. The image signals stored by the pixel electrode may be used to generate an electrical field between the respective pixel electrode and a common electrode. Such an electrical field may align liquid crystal molecules within an adjacent liquid crystal layer to modulate light transmission through the liquid crystal layer.

FIG. 2 illustrates an embodiment of the electronic device 10 in the form of a computer 30. The computer 30 may include computers that are generally portable (such as laptop, notebook, tablet, and handheld computers), as well as computers that are generally used in one place (such as conventional desktop computers, workstations, and servers). In certain embodiments, the electronic device 10 in the form of a computer may be a model of a MacBook™, MacBook™ Pro, MacBook Air™, iMac™, Mac™ Mini, or Mac Pro™, available from Apple Inc. of Cupertino, Calif. The depicted computer 30 includes a housing or enclosure 33, the display 12 (e.g., as an LCD 34 or some other suitable display), I/O ports 14, and input structures 16.

The display 12 may be integrated with the computer 30 (e.g., such as the display of a laptop or all-in-one computer) or may be a standalone display that interfaces with the computer 30 using one of the I/O ports 14, such as via a DisplayPort, DVI, High-Definition Multimedia Interface (HDMI), or analog (D-sub) interface. For instance, in certain embodiments, such a standalone display 12 may be a model of an Apple Cinema Display™ available from Apple Inc. As will be discussed below, the display 12 may include two or more common voltage lines and may be configured to reduce and/or compensate for errors that may be present between the kickback voltage associated with each of the two or more common voltage lines, thereby reducing the appearance of visual artifacts and/or improving color accuracy.

The electronic device 10 may also take the form of other types of devices, such as mobile telephones, media players, personal data organizers, handheld game platforms, cameras, and/or combinations of such devices. For instance, as generally depicted in FIG. 3, the device 10 may be provided in the form of a handheld electronic device 32 that includes various functionalities (such as the ability to take pictures, make telephone calls, access the Internet, communicate via email, record audio and/or video, listen to music, play games, connect to wireless networks, and so forth). By way of example, the handheld device 32 may be a model of an iPod™, iPod™ Touch, or iPhone™ available from Apple Inc.

In the depicted embodiment, the handheld device 32 includes the display 12, which may be in the form of an LCD 34. The LCD 34 may display various images generated by the handheld device 32, such as a graphical user interface (GUI) 38 having one or more icons 40. In another embodiment, the electronic device 10 may also be provided in the form of a portable multi-function tablet computing device 50, as depicted in FIG. 4. In certain embodiments, the tablet computing device 50 may provide the functionality of media player, a web browser, a cellular phone, a gaming platform, a personal data organizer, and so forth. By way of example, the tablet computing device 50 may be a model of an iPad™ tablet computer, available from Apple Inc.

The tablet device 50 includes the display 12 in the form of an LCD 34 that may be used to display a GUI 38. The GUI 38 may include graphical elements that represent applications and functions of the tablet device 50. For instance, the GUI 38 may include various layers, windows 60, screens, templates, or other graphical elements 40 that may be displayed in all, or a portion, of the display 12. As shown in FIG. 4, the LCD 34 may include a touch-sensing system 56 (e.g., a touchscreen) that allows a user to interact with the tablet device 50 and the GUI 38. By way of example only, the operating system GUI 38 displayed in FIG. 4 may be from a version of the Mac OS™ or iOS™ (e.g., OS X) operating system, available from Apple Inc.

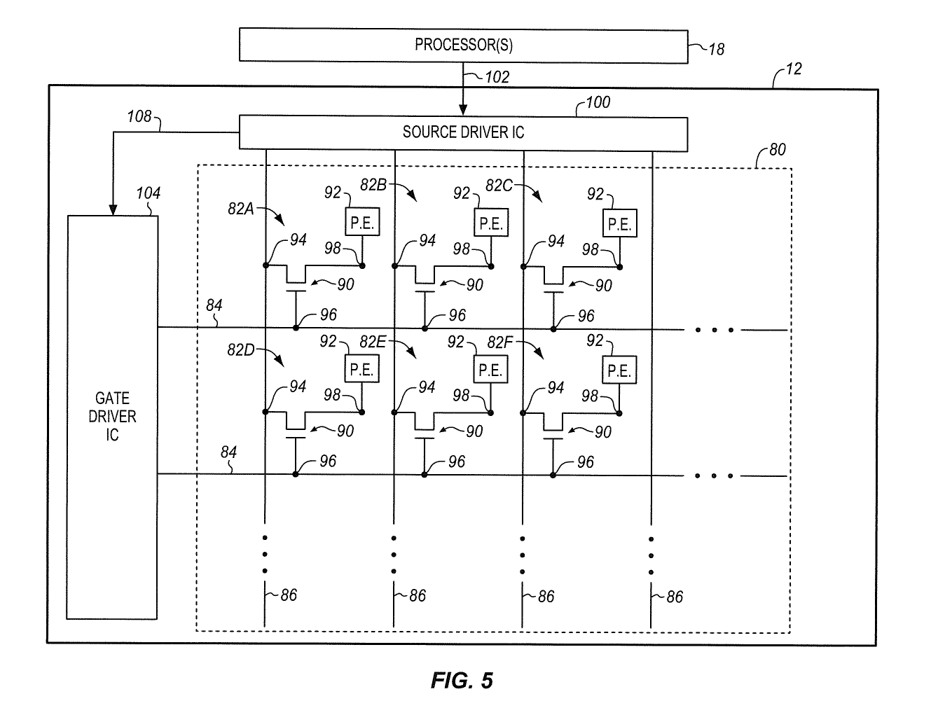

Referring now to FIG. 5, a circuit diagram of the display 12 is illustrated, in accordance with an embodiment. As shown, the display 12 may include a display panel 80, such as a liquid crystal display panel (e.g., LCD 34 of FIG. 2). The display panel 80 may include multiple unit pixels 82 disposed in a pixel array or matrix defining multiple rows and columns of unit pixels that collectively form an image viewable region of the display 12. In such an array, each unit pixel 82 may be defined by the intersection of rows and columns, represented here by the illustrated gate lines 84 (also referred to as “scanning lines”) and source lines 86 (also referred to as “data lines”), respectively.

Although only six unit pixels, referred to individually by the reference numbers 82a-82f, respectively, are shown for purposes of simplicity, it should be understood that in an actual implementation, each source line 86 and gate line 84 may include hundreds or even thousands of such unit pixels 82. By way of example, in a color display panel 80 having a display resolution of 1024×768, each source line 86, which may define a column of the pixel array, may include 768 unit pixels, while each gate line 84, which may define a row of the pixel array, may include 1024 groups of unit pixels, wherein each group includes a red, blue, and green pixel, thus totaling 3072 unit pixels per gate line 84. By way of further example, the panel 80 may have a display resolution of 480×320 or, alternatively, 960×640. As will be appreciated, in the context of LCDs, the color of a particular unit pixel generally depends on a particular color filter that is disposed over a liquid crystal layer of the unit pixel. In the presently illustrated example, the group of unit pixels 82a-82c may represent a group of pixels having a red pixel (82a), a blue pixel (82b), and a green pixel (82c). The group of unit pixels 82d-82f may be arranged in a similar manner.

As shown in the present embodiment, each unit pixel 82a-82f includes a thin film transistor (TFT) 90 for switching a respective pixel electrode 92. In the depicted embodiment, the source 94 of each TFT 90 may be electrically connected to a source line 86. Similarly, the gate 96 of each TFT 90 may be electrically connected to a gate line 84. Furthermore, the drain 98 of each TFT 90 may be electrically connected to a respective pixel electrode 92. Each TFT 90 serves as a switching element which may be activated and deactivated (e.g., turned on and off) for a predetermined period based upon the respective presence or absence of a scanning signal at the gate 96 of the TFT 90. For instance, when activated, the TFT 90 may store the image signals received via a respective source line 86 as a charge in its corresponding pixel electrode 92. The image signals stored by pixel electrode 92 may be used to generate an electrical field between the respective pixel electrode 92 and a common electrode (not shown in FIG. 5). As discussed above, the pixel electrode 92 and the common electrode may form a liquid crystal capacitor for a given unit pixel 82. Thus, in an LCD panel 80, such an electrical field may align liquid crystals molecules within a liquid crystal layer to modulate light transmission through a region of the liquid crystal layer that corresponds to the unit pixel 82. For instance, light is typically transmitted through the unit pixel 82 at an intensity corresponding to the applied voltage (e.g., from a corresponding source line 86).

The display 12 also includes a source driver integrated circuit (source driver IC) 100, which may include a chip, such as a processor or ASIC, that is configured to control various aspects of display 12 and panel 80. For example, the source driver IC 100 may receive image data 102 from the processor(s) 18 and send corresponding image signals to the unit pixels 82 of the panel 80. The source driver IC 100 may also be coupled to a gate driver IC 104, which may be configured to activate or deactivate rows of unit pixels 82 via the gate lines 84. As such, the source driver IC 100 may send timing information, shown here by reference number 108, to gate driver IC 104 to facilitate the activation and d deactivation of individual rows of pixels 82. In other embodiments, timing information may be provided to the gate driver IC 104 in some other manner. While the illustrated embodiment shows only a single source driver IC 100 coupled to panel 80 for purposes of simplicity, it should be appreciated that additional embodiments may utilize multiple source driver ICs 100 for providing image signals to the pixels 82. For example, additional embodiments may include multiple source driver ICs 100 disposed along one or more edges of the panel 80, wherein each source driver IC 100 is configured to control a subset of the source lines 86 and/or gate lines 84.

In operation, the source driver IC 100 receives image data 102 from the processor 18 or a discrete display controller and, based on the received data, outputs signals to control the pixels 82. For instance, to display image data 102, the source driver IC 100 may adjust the voltage of the pixel electrodes 92 (abbreviated in FIG. 2 as P.E.) one row at a time. To access an individual row of pixels 82, the gate driver IC 104 may send an activation signal to the TFTs 90 associated with the particular row of pixels 82 being addressed. This activation signal may render the TFTs 90 on the addressed row conductive. Accordingly, image data 102 corresponding to the addressed row may be transmitted from source driver IC 100 to each of the unit pixels 82 within the addressed row via respective data lines 86. Thereafter, the gate driver IC 104 may deactivate the TFTs 90 in the addressed row, thereby impeding the pixels 82 within that row from changing state until the next time they are addressed. The above-described process may be repeated for each row of pixels 82 in the panel 80 to reproduce image data 102 as a viewable image on the display 12.

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

In order to avoid the differences between semiconductors formed in silicon and semiconductors formed on glass, a silicon substrate is formed on a portion of the glass substrate that is not used for the display. Drivers, voltage controllers and other circuitry may be built on this silicon substrate. However, the display elements, such as charge storage circuits, e.g. liquid crystal capacitors, and their connected switch elements (TFTs) are still formed on the glass substrate.

The gate leakage of a transistor affects the voltage that must be applied to the gate in order for the transistor to turn on. In accordance with an embodiment of the invention, the gate leakage of a replica transistor, which replicates an original switch element TFT of a pixel, that has been formed on a display panel substrate is characterized, and then the gate voltage applied by the gate driver circuit of the display system to drive the original switch element TFT can be adjusted based on the characterization, to compensate for changes in the gate leakage that have occurred over time.

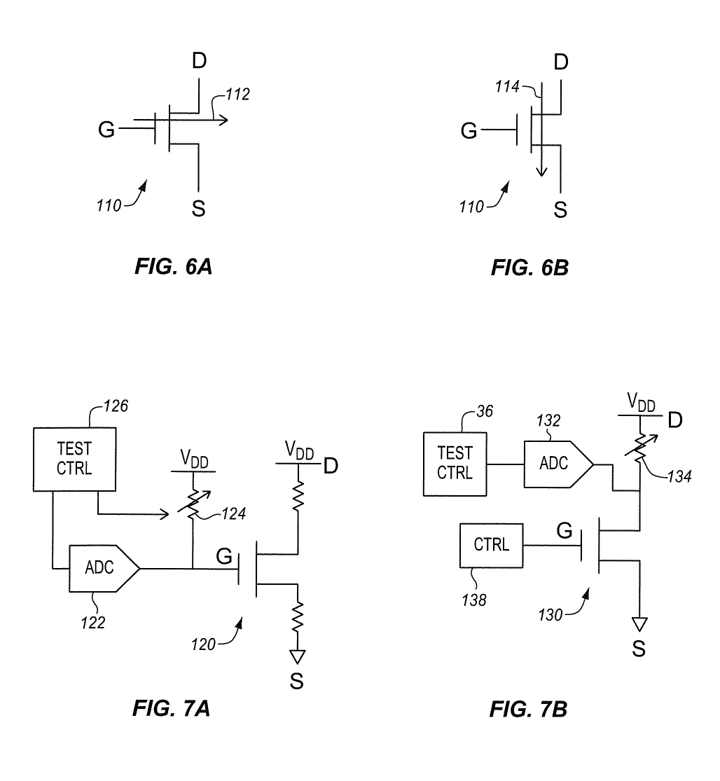

FIG. 6A is a diagram of a transistor showing an example of gate leakage. The transistor 110 in this example is an n-type field effect transistor, such as a TFT formed on a glass substrate, which has a source S, a drain D and a gate G. The leakage current is shown by the arrow 112. If a constant gate voltage signal is applied, then the effectiveness of that constant signal will be reduced over time as the leakage increases.

Another electrical characteristic of concern with TFTs on glass is cut-off leakage current. FIG. 6B is a diagram of the same transistor 110 showing an example of drain current. In this case the arrow 114 shows that current leaks from the drain to the source even while the transistor has been turned off (or is in cut-off), by virtue of an appropriate gate voltage being applied to the gate electrode. An increase in the cut-off (drain) leakage current over time may present difficulties for the display element array.

FIG. 7A shows an example of an apparatus for measuring the leakage of current applied to the gate of the transistor as shown in FIG. 6A. In FIG. 7A a supply voltage V_{DD} is applied to the drain D of the transistor 120. The source S is coupled to ground or an opposite polarity (or return node) of the power supply. An ADC (Analog to Digital Converter) 122 senses the gate voltage and a test controller 126 will compute the leakage current that flows through the gate as a function of the sensed gate voltage, the resistance of the variable resistor 124 (which is being used to sense the leakage current) and the regulated power supply voltage V_{DD}. Other circuits that can accurately measure the gate leakage current of a TFT can alternatively be used.

FIG. 7B shows an example of an apparatus to measure drain current through a transistor 130. This circuit may be used to measure not just the TFT's drain current in the cut-off region, but also its drain current in the linear and saturation regions of operation. In this case, the drain is coupled to V_{DD} through a variable load 134 which can sweep the transistor through its linear and saturation modes of operation. A gate controller 138 sets the gate voltage of the transistor to place the transistor in the desired region of operation. An ADC 132 coupled to the drain measures the voltage at the drain of the transistor, which is then translated by a test controller 136 into a measured drain current, through knowledge of the resistance of the variable load 134 and the regulated supply voltage V_{DD}. The gate voltage and the load 134 can thus be swept under control of the test controller 136, while the drain current is measured so as to fully characterize the transistor by measuring its V_{DS}-I_{D} behavior. Other circuits that can accurately measure the source or drain current of a TFT while sweeping the transistor through its different regions of operation can alternatively be used.

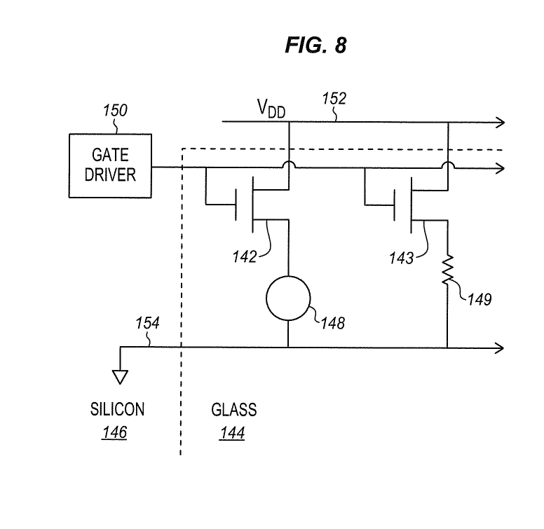

FIG. 8 shows an application of the test apparatus of FIGS. 2A and 2B to characterize display circuitry on a glass substrate. Two transistors 142, 143 are shown although there may be many more, typically millions of transistors, depending on the particular display system. The transistors may be formed on a glass substrate 144 for improved packaging and efficiency. The first transistor drives a pixel element 148 of the display. The pixel element may be a liquid crystal element, a diode, or any other type of local display element. The second transistor 143 is a replica transistor used for characterizing the behavior of the first transistor 142 without affecting the use of the display. The second transistor 143 drives a resistor 149 or any other load that has similar characteristics to a pixel element for the particular display. In some cases, a capacitor may more closely resemble the characteristics of a liquid crystal capacitor of a display element. The first transistor can be referred to as the original transistor and the second transistor as the replica transistor because its characterization is used as a characterization of the original transistor.

Both resistors are coupled to a supply voltage V_{DD} rail 152 and to a common or ground rail 154. A gate driver 150 drives the gates of both transistors. The first, original transistor 142 is driven to produce the intended images on the display. The second, replica transistor 143 is driven to emulate the behavior and load that is experienced by a particular display transistor, such as the first transistor 142. As the display transistor 142 ages with time and use, the replica transistor 143 will also age in a similar way. By characterizing the replica transistor, the system is able to closely approximate the characteristics of the original or display transistor. The gate driver circuit 150 has a compensation facility (a circuit) to allow it to compensate for the effects of wear, use, and environmental exposure. The compensation facility may include a set of configurable parameters to adjust various voltages or it may be a simpler or more complex structure depending upon the design of the gate driver.

As shown in FIG. 8, the first and second transistors 142, 143 and the loads are all formed on the glass substrate 144. As a result, the two transistors may be made similar in structure and materials and exposed to the same environment. The replica transistor may be formed on a part of the glass substrate that is not visible to the user. Typically, is not necessary for the replica transistor to be exposed to the backlight for displays that use a backlight. As a result, the replica transistor may be placed in a location that is not used for the visible display to the user.

Alternatively, since a single replica transistor 143 and its load are very small, it may be possible to place it in the midst of the display without being noticed by a user. Note that while the actual load 149 for the replica transistor may be formed on the glass substrate 144 for compactness or to replicate the electrical leads of the first transistor. It may alternatively be formed on silicon for reliability or accuracy, depending on the form of the load. The supply voltage, the ground, and the gate driver may all be formed on a silicon substrate 146. This silicon substrate may be formed on the glass substrate 144 or it may be formed in a separate location.

While only two transistors are shown, this is in order to simplify the drawing. For each transistor type that is formed on the glass substrate, there may be one or more replica transistors that replicate the structure and duty cycle of that transistor. As each different type of transistor is characterized the supply voltage and gate driver signal can be adjusted for that particular transistor type using, for example, a compensation facility of the gate driver or another approach.

As an alternative to the common gate driver shown in FIG. 8, the replica transistor may have its own gate driver or it may receive gate signals from the gate driver that are specifically intended to represent a normal duty cycle for a transistor of its type.

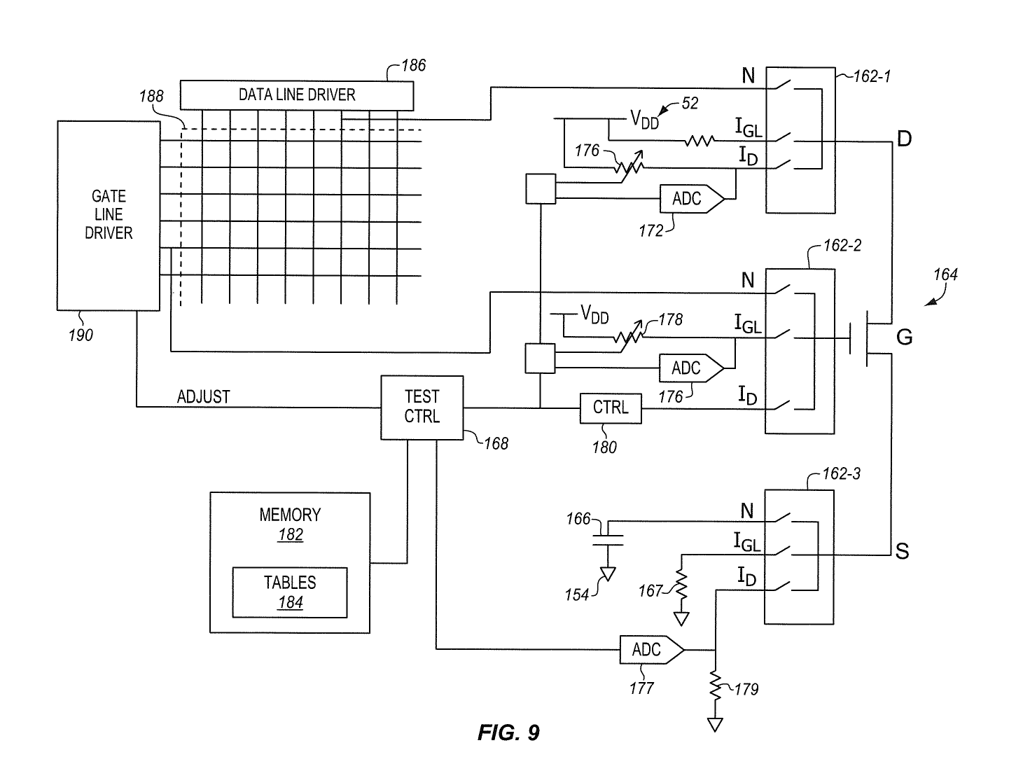

FIG. 9 shows an example of the replica transistor 164 coupled to test hardware. As in FIG. 8, the test hardware may be on a silicon substrate while the replica and, optionally, a load are on the glass substrate. The source of the replica transistor is coupled to a multiplexer 162-1 that allows any of three different inputs, normal N, gate leakage current I_{GL}, or drain current I_{D} to be selected. This allows the replica transistor to be operated normally or in either of the two test modes mentioned above with respect to FIGS. 6A and 6B. In this particular example for the first mode, normal operation, the replica transistor's drain D is coupled to a data line driver 186 of the display 188. This allows the replica transistor 164 to be driven in the same way as an original or display transistor (not shown). The display 188 is an LCD or OLED display as described above with millions of pixels, each controlled by the data line driver 186 and a gate line driver 190.

For the second mode, I_{GL}, the drain is coupled to the supply voltage V_{DD} 152 which is also connected to the multiplexer 162-1. The third drain connection I_{D} allows a controllable ADC 172 and a variable resistor 174 to be coupled to the drain for a current drain test as described above in the context of FIG. 7B. The ADC converts the measured current to a digital value that is provided to the test controller 168 as the test controller controls the variable resistor.

Similarly a second multiplexer 162-2 allows three different connections to be made to the gate G to support the three modes discussed above. A normal connection N allows for normal operation of the transistor to emulate typical operation of transistors of this type in operation on the display. The gate line driver 190 of the display 188 is coupled to the display transistors and also to the gate of the replica transistor 164.

The second connection I_{GL} provides the equipment suitable for a gate leakage test with a controllable voltage supplied to the gate though a variable resistor 178 under control of the test controller. An ADC 176 also coupled to the test controller measures leakage through the gate as shown in FIG. 7A. The third connection for I_{D} allows the state of the gate G to be controlled by a gate controller 180 or a control line to set the gate to an OFF state. This allows current flow from the drain D to the source S through the OFF gate. The controller may also set the gate to other states, if desired.

A third multiplexer 162-3 is coupled to the source S to allow the source to be coupled in one of three ways to support normal operation and the different tests described above.

As in the above examples, there is a normal operation line N, a gate leakage line I_{GL}, and drain current line I_{D} to permit different operational and test modes. The normal operation line is coupled to ground 154 through a capacitive load 166 that simulates the load of the liquid crystal capacitor of a display pixel. The I_{GL} line is coupled to ground through a resistive load 167.

For the current drain mode I_{D}, the line is also grounded through a resistive load 179. However, an additional ADC 177 may be used as shown coupled to the line before the load to measure the current through the line to the source. This ADC may also be coupled to the test controller. Current measurement at the source 172 and also at the drain 177 allows the replica transistor to be characterized even more accurately.

The multiplexers 162-1, 162-2, 162-3 are all connected together or, alternatively, may be coupled to a common test controller 168. The test controller controls the operational mode of the replica transistor 164 by controlling the operation of the three multiplexers as well as the values provided to the variable resistors 176, 178 and the gate controller 180. Alternatively, the controller may control the gate directly instead of through the gate controller. The controller 168 also receives digital current reading values directly from the ADCs 172, 176, 177 when a test mode is entered.

The test controller 168 is coupled to a memory 182 in which a table is stored 184. This memory may be used for instruction sequences, interrupts, and parameters. The table of the memory may also be used to store the test results that characterize the replica transistor. This or another controller may then use these test results to adjust operational parameters for the transistors of the display 188. The measurement values stored in the table may be actual current measurements made under different circumstances or an indication of these measurements. The test controller may pre-process the measurements in any of a variety of ways. In one example, the table is used only to store adjustment parameters for the gate line driver. These adjustment parameters are an indication of the current measurements in that they are derived using the current measurements.

The test controller 168 is coupled to the gate line driver 190 in order to make these adjustments. As the parameters for operation of the display transistors are adjusted, the same adjustment may be made for the operation of the corresponding replica or dummy transistors 164. The adjustments may include changing the drain voltage supplied to particular transistor or on a voltage rail and changing the voltage applied by a gate driver to one or more of the display transistors. This adjustment may be made by the test controller to the voltage supply and gate driver circuitry or another device can access the parameters in the table 184 to make the adjustments.

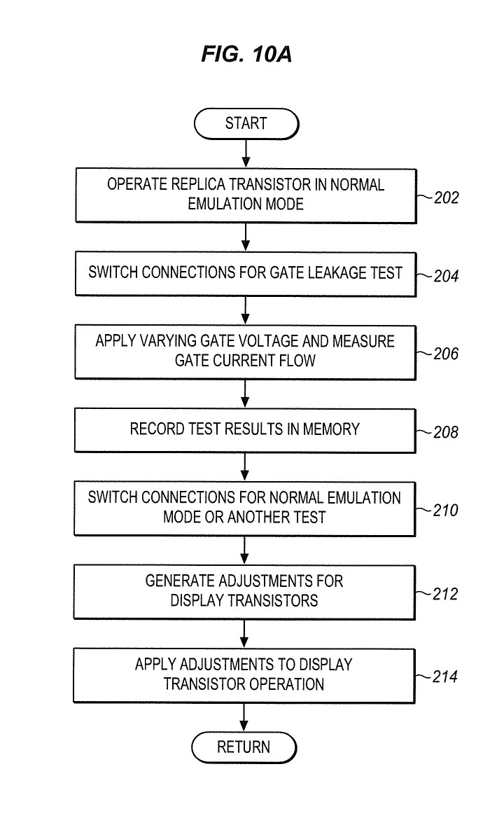

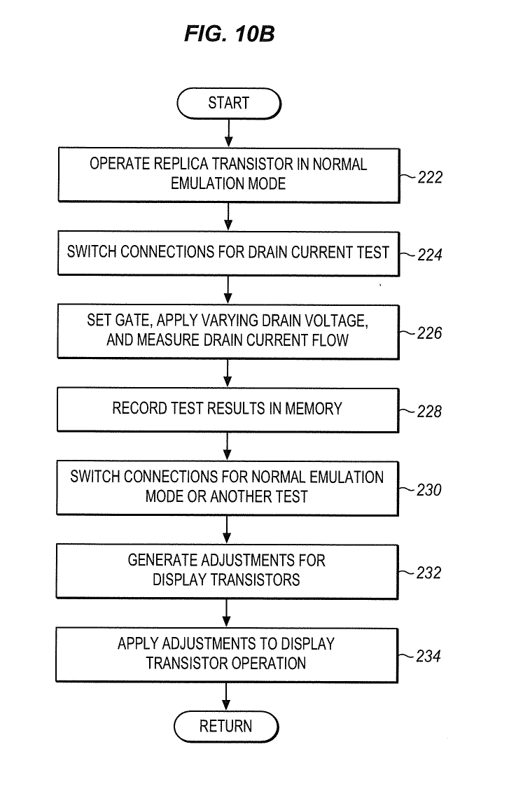

FIG. 10A is a process flow diagram for characterizing a transistor using a gate leakage test. The process may run at all times that the display is operated. The process starts when the display is brought into use, such as at power on of the attached device. At 202 the replica transistor is operated in normal emulation mode. As mentioned above, in this mode the replica transistor drives its load based on gate driver inputs in a way that emulates a typical duty cycle or operation of the original or display transistors that are used to generate images for the users.

At 204, the connections to the replica transistor are switched using, for example, the multiplexers shown in FIG. 9 in order to start a gate leakage test. The gate leakage test can be performed in any of a variety of different ways. In one example, at 206 a varying gate voltage is applied to the gate and the current flow through the gate is measured at each voltage. The voltage may be stepped or swept through a range. At 208, test results are recorded in memory and then at 210 the connections to the replica transistor are switched back for normal emulation mode or for another test.

At 212 the test results are accessed in order to generate adjustments to be applied to the transistors of which the replica transistor is a replica. A primary type of transistor is a display transistor but replicas can be made that allow other types of transistors to be characterized as well. The test results stored in memory characterize the gate leakage of the replica transistor at a range of different gate voltages. The adjustments based on the replica transistor behavior represent a similarity to the characteristics of the display transistors. At 214 these adjustments are applied to the operation of the display transistors. The process flow then returns to the start with the replica transistor being operated in a way to emulate the operation of the display transistors.

FIG. 10B shows a similar process flow for a current leakage test. The operation starts with the replica transistor at 222 operating in a normal emulation mode as described above. At 224 the connections of the replica transistor are switched to support a drain current test. This test may be performed in a variety of different ways. The approach of FIG. 7B and at 226 is to set the gate voltage to set the gate to OFF using a first controller, apply a varying drain voltage, and then measure the drain current flow. The current flowing from the drain may be measured in a variety of other ways as well.

At 228 the test results are recorded in memory, such as in a table associated with a test controller. Then, having completed the test and stored the results, the connections are switched at 230 for the replica transistor to enter normal emulation mode or for another test. Before the connections are switched, the test may be repeated or different variations may be made to the test or one or more different tests may be performed.

At 232 adjustments are generated for the display transistors using the test result data, then at 234 these adjustments are applied to the display transistor operation. The process flow then returns to normal operation until another test is performed.

The two tests, the gate leakage and the drain current tests can be triggered based on a clock or an event. The tests may be performed after a certain number of hours or days of operation, on power up, upon entering standby, etc. While only two different types of tests are described other and additional tests may be performed. Both tests may be performed in sequence before switching the connections back to normal emulation mode.

While the transistors in the figures are shown as n-type MOSFETs (Metal Oxide Semiconductor Field Effect Transistors), similar approaches may be used with p-type MOSFETs and with other types of transistors. The techniques described herein may be adapted also to suit a variety of different types of substrates for the display, both transparent such as glass and opaque, whether plastic, glass, or another silicon-based material.

While the original transistor shown, for example, in FIG. 8 is a display TFT, the same approach may be applied to other types of transistors. In Gate on Array technology, other transistors, including gate driver transistors may be fabricate on a glass or other transparent substrate. Alternatively, the original transistor may be a different TFT, such as a part of a multiplexer or demultiplexor circuit or a data line driver. A replica transistor may be provided to emulate the operation conditions of any of these other transistors.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although the switch element shown in FIG. 9 is an n-channel field effect transistor whose gate is coupled to a gate line and whose drain is coupled to a data line, the gate driver circuitry may also work for driving other types of switch elements, including ones that may have more complex designs such as multiple transistors, or ones with a more simple design such as a single diode. The description is thus to be regarded as illustrative instead of limiting.

What is claimed is:

1. A display system comprising:
a display substrate having formed thereon a plurality of pixels, gate line drivers, and data line drivers, wherein the pixels and the gate and data line drivers have an original transistor formed on the substrate, the original transistor being a constituent part of one of the pixels, at least one of the gate line driver and the data line driver being driven by a transistor drive circuit;
a replica transistor formed on the substrate that is a replica of the original transistor and is coupled to be driven so as to emulate the original transistor;
a replica test circuit to apply a test voltage to the replica transistor and to measure current through the replica transistor while applying the test voltage so as to characterize the replica transistor; and
a compensation facility in the transistor drive circuit to adjust a voltage that is applied to drive the original transistor, based on the replica transistor characterization.

2. The display of claim 1, wherein the replica test circuit applies a plurality of voltages to the gate of the replica transistor and measures current through the gate for the plurality of voltages.

3. The display of claim 1, wherein the replica test circuit applies a plurality of voltages to the source of the replica transistor as the replica transistor is in an OFF mode and measures current through the source for the plurality of voltages.

4. The display of claim 1, further comprising a multiplexer coupled to the replica transistor at an output and the transistor drive circuit and the replica test circuit at an input to alternately connect the replica transistor to the transistor drive circuit and the replica circuit.

5. The display of claim 4, the multiplexer comprising an output coupled to the source of the replica transistor to alternately connect a drain voltage and a test voltage to the transistor.

6. The display of claim 4, the multiplexer comprising an output coupled to the gate of the transistor to alternately connect a gate driver to emulate normal operation and a test voltage to test gate leakage.

7. The display of claim 6, the multiplexer output to alternately connect a gate controller to the gate to set the gate to an OFF state when conducting a leakage test.

8. The display of claim 1, wherein the transistor drive circuit comprises a gate driver and wherein the compensation facility comprises parameter settings in the gate driver.

9. The display of claim 1, wherein the display substrate is formed of glass.

10. The display of claim 1, wherein the transistor drive circuit and the replica test circuit are formed on a silicon substrate.

11. The display of claim 10, wherein the silicon substrate is formed on the display substrate.

12. A method comprising:
operating a replica transistor on a display substrate in a normal mode to emulate the operation of an original transistor also formed on the display substrate, wherein the original transistor is a constituent part of one of a plurality of pixels, gate line drivers, and data line drivers, at least one of the gate line driver and the data line driver being driven by a transistor drive circuit;
connecting the replica transistor to a test circuit;
characterizing the replica transistor using the test circuit by applying a test voltage to the replica transistor and measuring current through the replica transistor while applying the test voltage so as to characterize the replica transistor;
storing a representation of the current measurements in a memory;
disconnecting the replica transistor from the test circuit after characterizing the replica transistor;
adjusting parameters of the transistor drive circuit based on the stored measurement indications.

13. The method of claim 12, wherein characterizing the replica transistor comprises applying a plurality of different voltages to a gate of the replica transistor and measuring current flow through the gate.

14. The method of claim 13, wherein characterizing the replica transistor comprises applying a plurality of different voltages to a drain of the replica transistor and measuring current flow through the drain with the gate in an OFF mode.

15. The method of claim 12, further comprising generating adjustments for the original transistor using the stored current measurements and wherein adjusting parameters comprises adjusting parameters using the generated adjustments.

16. The method of claim 12, wherein the original transistor is a display transistor.
